(19) United States
(12) Patent Application Publication
(10) Pub. No.: US 2007/0224431 A1
(43) Pub. Date: Sep. 27, 2007

(54) Heat resistant powder coatings

(76) Inventors: Owen H. Decker, Houston, TX (US); Wenjing J. Zhou, Cypress, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/728,516

(22) Filed: Mar. 26, 2007

Related U.S. Application Data
(60) Provisional application No. 60/786,419, filed on Mar. 27, 2006.

(51) Int. Cl. B32B 9/04; C08L 83/04

(52) U.S. Cl. 428/447; 524/405; 524/588; 524/904

(57) ABSTRACT

The invention provides a melt-blendable, film-forming, thermosetting, powder coating composition for producing a high temperature resistant coating, the composition is particularly useful for coating substrates subjected to high temperatures, such as, boilers, ovens, furnaces, stove burners, steam lines, heat exchangers, barbeque equipment, cooking utensils, the powder coating composition comprises
A) at least one polysiloxane resin, and
B) 0.01 to 50 parts by weight (pbw) based on 100 pbw binder of at least one inorganic anhydrous borate based on at least one alkali metal.

### CROSS-REFERENCE TO RELATED APPLICATION

This application claims the benefit of U.S. Provisional Application Serial No. 60/786,419 filed on Mar. 27, 2006 which is hereby incorporated by references in its entirety.

### FIELD OF THE INVENTION

The present invention relates to a thermosetting powder coating composition which provides high temperature resistant coatings with enhanced adhesion onto substrates which are likely to be subjected to elevated temperatures.

### BACKGROUND OF THE INVENTION

It is known that powder coatings incorporating polysiloxane resins have high heat resistance, see, for example, U.S. Pat. No. 5,905,104. While there have been various polysiloxane based powder coating compositions proposed over the years, there is still the problem of rapid shrinkaging and embrittlement of the coatings causing them to readily crack and peel from the substrate or flake off the substrate when conventional thermoset polysiloxane powder coated materials are exposed to temperatures of 550° C. (1022° F.) or upward including red hot conditions. Various attempts have been made to solve this problem, e.g., through incorporation of reinforcing fillers into the coating composition, with only limited success. For example, U.S. Pat. No. 5,684,066 and U.S. Pat. No. 5,962,568 describe reinforcing fillers that are needle-like or disc-shaped in structure. They are in general used to prepare heat-resistant powder coatings with improved stability. U.S. Pat. No. 5,998,560 and U.S. Pat. No. 6,248,824 offer special reinforcing fillers, such as, high-aspect ratio fillers of wollastonite (calcium metasilicate), and mica (various sodium and potassium aluminum silicates) or aluminum flakes. These types of fillers are often effective at minimizing shrinkage, slowing cracking and delamination up to about temperatures of 550° C.

WO 2004/076572 discloses a powder coating composition comprising a high temperature silicone based resin combined with low-melting inorganic glass particles or inorganic crystalline particles to achieve high heat resistant coating powders. The components of such powder coating compositions can be dry-blended, but the use of melt-blending methods to manufacture the powder coating composition shows insufficient film-forming effects of the coatings. Although low-melting glasses containing significant levels of, for example, both silicon oxides and alkalie metal oxides can be dry-blended as particulates with polysiloxane resin-based coating powders, and applied together as a coating powder, they appear to be too reactive with the polysiloxane resins to be combined using the melt-mixing process traditionally used to manufacture powder coatings.

For high temperature applications, such as, automotive exhaust parts, barbeque grills, stove burners, or the like, powder coating compositions are desired which have the advantages in handling of melt-blended powder components, and provide coatings withstanding use temperatures above 550° C. (1022° F.).

### SUMMARY OF INVENTION

The invention provides a melt-blendable, film-forming, thermosetting, powder coating composition for producing a high temperature resistant coating, the composition is particularly useful for coating substrates subjected to high temperatures, such as, boilers, ovens, furnaces, stove burners, steam lines, heat exchangers, barbeque equipment and cooking utensils. The coating composition of this invention provides a coating with excellent heat resistant characteristics and in particular with highly improved resistance to adhesive failure, such as, delamination when exposed to high temperatures. The components of the composition according to the invention can be extruded and provide coatings with enhanced appearance.

The powder coating composition of the present invention comprises
A) at least one polysiloxane resin, and
B) 0.01 to 50 parts by weight (pbw) based on 100 pbw binder of at least one inorganic anhydrous borate based on at least one alkali metal.

Articles comprising one or more layers of these coating materials are also included in this invention.

### DETAILED DESCRIPTION OF THE INVENTION

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The total of the polysiloxane resin plus any other type of binder resin is expressed as 100% by weight of binder and all other components of the coating powder composition, such as, the matrix materials, fillers, pigments, flow control agents, cure catalyst, etc. are expressed as parts by weight (pbw) based on 100 pbw of binder. Polysiloxane resins as used herein are also often referred to as silicones or polysiloxanes or polysiloxane polymers.

The heat-resistant properties of the polysiloxane based powder coatings according to the invention can be improved by incorporating into the coating composition anhydrous borates based on alkali metals which combine with the polysiloxane resin and improve the adhesion of the polysiloxane resin in the temperature range in which polysiloxane coatings suffer loss of their organic components, causing films based on them to undergo rapid shrinkage and embrittlement. The coating composition according to the invention including the anhydrous borates based on alkali metals can be melt-blended without reaction to the extent that the melt solidifies at extrusion temperatures.

The compositions of the present invention are intended to withstand temperatures whereas most organic components, including organic moieties of the polysiloxane resin, burn away. Accordingly, it is a desire that coatings of the present invention withstand, for example, temperatures of 550° C. (1022° F.) and upward, although end use temperatures and other requirements of the coating powder may vary according to the particular coating application.

By “improved heat-resistant characteristics”, it is meant that a coating formed on a substrate from the powder coating composition of this invention will retain its adhesion after exposure to temperatures of 550° C. or above without any delamination.

The coatings of this invention are particularly useful on articles which are subjected to elevated temperatures including stacks, mufflers, manifolds, boilers, ovens, furnaces, steam lines, heat exchangers, barbeque equipment, cooking utensils and other articles which are subject to elevated temperature.

The compositions of the present invention preferably contain high amounts of polysiloxane resin in the resin system. A resin system which is essentially all polysiloxane, as in accordance with the preferred embodiment of this invention, provides stability at the highest temperatures, having minimal amounts of organic substituents and therefore, minimal shrinkage as the organic substituents oxidize away. The organic substituent fraction of typical polysiloxane resins used for powder coatings ranges from about 30 to about 60% of the total resin weight.

Accordingly, in the preferred embodiment of the present invention the compositions of this invention have a resinous binder system which comprises essentially 100% by weight of a polysiloxane resin or blend of polysiloxane resins. At temperatures of about 140-260°0 C., polysiloxane resins of this invention will self-condense to form a crosslinked network.

The coating powders of this invention can also contain lesser amounts of polysiloxane resins depending on the particular application. When lesser amounts are used, the coating powders of this invention typically comprise from about 10 to 100% by weight polysiloxane resin based on the total weight of the binder, preferably from about 50 to 100%, and most preferably from about 80 to 100% by weight.

The polysiloxane resins suitable for use herein can be any alkyl and/or aryl substituted polysiloxane, copolymer, blend or mixture thereof, the alkyl substitution preferably selected from short chain alkyl groups of 1 to 4 carbon atoms, more preferably 1 to 3 carbon atoms, and most preferably methyl or propyl and the aryl substitution most preferably comprises phenyl groups. For good heat-resistance, methyl and phenyl groups are the organic moieties of choice. Generally the more methyl groups the less coating shrinkage is observed on heat exposure. For forming powder coatings, the polysiloxane resins should be solid at room temperature and preferably have a Tg (glass transition temperature) of at least 45° C. and be able to be melt processed at temperatures less than 200° C. Examples of such polysiloxane resins are phenylsilicone Silres® 601 or methylsilicone Silres® MK, available from Wacker Silicone, Adrien, Mich., and proplyphenyl Z-6018 or methylphenylsilicone 6-2230 available from Dow Corning, etc. Suitable resins are also described in U.S. Pat. No. 3,585,065, U.S. Pat. No. 4,107,148, U.S. Pat. No. 3,170,890 and U.S. Pat. No. 4,879,344, incorporated herein by reference.

The organic moieties on polysiloxane resins can also bear organic functional groups, such as, COOH, NCO, amine, epoxy functional groups, etc., such as, are disclosed in U.S. Pat. No. 6,046,276, U.S. Pat. No. 6,274,672, U.S. Pat. No. 6,376,607, U.S. Pat. No. 5,280,098 and U.S. Pat. No. 5,516,858, incorporated herein by reference, for added mechanical properties and enhanced reactivity with the film forming resins used in the resin system.

Preferably, for added heat resistance, good melt processability at temperatures less than 200° C. and susceptibility to undergo crosslinking reactions, a hydroxyl-functional polysiloxane is used, with the hydroxyl-functionality up to about 10% by weight, preferably in a range from about 0.5% by weight to about 10.0% by weight, based on the total polysiloxane solids.

Examples of commercially available hydroxyl-functional polysiloxanes include Dow Corning® 1-0543, Dow Corning® 6-2230 and Dow Corning® Z-6018 from Dow Corning (Midland, Mich.); Wacker Silres® MK and Wacker Silres® 601, 602, 603, 604 and 605 from Wacker Silicone Corp., (Adrien, Mich.); General Electric SR-355 from General Electric (Waterford, N.Y.); and PDS-9931 from Gelest, Inc., (Tullytown, Pa.). Other suitable polysiloxane-based polymers include those described in U.S. Pat. No. 4,107,148 and U.S. Pat. No. 4,879,344, incorporated herein by reference.

The powder coating compositions of this invention may also contain, if at all present, one or more resins commonly used in such coatings and well known in the art. These resins, if used, will make up the balance of the binder system. Such resins include organic polymers and oligomers including those based on epoxy resins, polyester resins, acrylic resins and/or urethane resins, such as, those described in U.S. Pat. No. 5,998,560, incorporated herein by reference. When acrylic polymers are present in the powder coating composition, they may be glycidyl, hydroxy or carboxylic acid-functional acrylic polymers.

The powder coating composition according to the invention contains as component B) at least one inorganic anhydrous borate comprising oxides of boron and of at least one alkali metal. These materials provide the desired properties as already mentioned above. Such borates are solids, may be crystalline or amorphous, or combinations of the two at room temperature, and react with polysiloxane resins in the temperature range in which polysiloxane resins suffer loss of their organic components and undergo rapid shrinkage and embrittlement. These alkali metal borate-modified polysiloxane films exhibit superior adhesion to films lacking alkali metal borates.

Preferably, the alkali metal borates of the invention are present in the range from 0.5 to 50% pbw based on 100 pbw of binder, more preferably from 2 to 30% pbw, and most preferably from 5 to 20% pbw.

The term anhydrous borate based on at least one alkali metal means borates which do not contain water or contains water in very small quantities, based on the borate compound, e.g., in a range of 0.1 to 10%.

Anhydrous borates useful according to the invention based on at least one alkali metal selected from the group of alkali metals consisting of lithium, sodium, potassium and rubidium. Preferred are anhydrous borates based on at least one alkali metal wherein the alkali metal is sodium and/or lithium.

Examples of anhydrous borate based on at least one alkali metal are sodium tetraborate, lithium tetraborate, and anhydrous borax manufactured, for example, by Pfaltz & Bauer, Noah Technologies and Rio Tinto Borax.

A useful feature of these borates is that they are convenient to introduce into a coating powder. The alkali borates can be supplied to the coating-manufacturing process in any shape or size. To provide convenience in use, it is preferred that the particles be below about 100 microns in their largest dimension, so that they will not induce roughness in the coating and so that they can be minutely dispersed. The upper limit of the size of the borate particles is dependent on the intended thickness of the final coating in that the particles should have a size less than the coating thickness. Most powder coatings are designed to be applied at a dry film thickness of about 50 microns. Thus, in most applications, the particles should have a maximum size in their largest dimension of less than about 50 microns, preferably 40 microns.

Reinforcing fillers may be added to the powder coating composition according to the invention to improve the properties regarding resistance to abrasion and physical damage of the coatings. These reinforcing fillers are well-known in the art and include needle-like materials, such as, wollastonite (calcium silicate), plate-like materials, such as, micas (potassium aluminum silicates), fibrous materials, such as, asbestos, and various man-made fibrous, rod-shaped or plate-like refractory materials including silicate glasses. Glass particles may also be used as reinforcing fillers. Typical examples include Nyad® M 400, a wollastonite filler supplied by Nyco Corporation, Willsboro, N.Y.; and Suzorite® 325 HK, a phlogopite mica supplied by Suzorite Mica Products, Inc., of Boucherville, Quebec, Canada. Other examples include materials reported in the patent literature referenced herein.

It may be desirable to include high-aspect-ratio fillers, such as, those described in U.S. Pat. No. 6,248,824, incorporated herein by reference.

Reinforcing materials, if at all present (that is above 0% by weight) are typically included in a range from about 5 to 50 pbw per 100 pbw binder of the composition, preferably from about 10 to 40 pbw.

In addition to the required polysiloxane resins and the high temperature matrix materials and the sometimes desirable reinforcing fillers, the powder coating compositions of this invention may contain other additives that are conventionally used in powder coating compositions and in high use temperature powder coatings. These additives include: adhesion promoters; fillers; pigments; flow and leveling additives; degassing aids; gloss-modifying agents; cratering agents; curing agents; cure catalysts; texturizers; surfactants; organic plasticizers; agents to improve electrostatic application properties; agents to improve corrosion resistance; agents to improve the dry-flow properties of the powder; and the like.

While polysiloxane resins self-condense at elevated temperatures to form a crosslinked network, it is often desirable to employ small quantities of a cure catalyst, such as, stannous octoate, dibutyl tin dilaurate, zinc octoate, zinc acetylacetonate, zinc neodecanoate and their mixtures, so as to achieve rapid gel time. Typically at least about 0.1 pbw of the binder content of such cure catalyst is employed, up to about 2 pbw.

Flow control agents can be present in the powder-based compositions up to about 3.0% by weight, and preferably from about 0.5 to 1.5 pbw based on the total binder content. The flow control agents may include acrylics, polysiloxanes and fluorine-based polymers. Examples of commercially available flow control agents include Resiflow® PL-200 and Clearflow® Z-340. from Estron Chemical, Inc. (Calvert City, Ky.); Mondaflow® 2000 from Monsanto (St. Louis, Mo.); Modarez®. MFP from Synthron, Inc. (Morgantown, N.C.); and BYK® 361 and BYK®. 300 from BYK Chemie (Wallingford, Conn.).

Degassing agents can be used in the powder-based compositions to assist in the release of gases during the curing process. These materials are typically present in a range from about 0.1 to 5.0 pbw based on the total binder content. Examples of a commercially available degassing agents include Uraflow® B from GCA Chemical Corporation (Brandenton, Fla.) and Benzoin from Estron Chemical (Calvert City, Ky.).

It is also often desirable to employ a dry-flow additive, so as to improve dry-flow characteristics of the powder-based compositions. Examples include fumed silica, aluminum oxide and their mixtures. These materials are typically present in a range form about 0.05 to 1 pbw based on the total binder content.

If desired, other optional ingredients, such as, inorganic fillers can be used in combination with the reinforcing fillers already mentioned to provide texture, control gloss, and increase the coatings volume to enhance its economics. Optional other additives, such as, any of those listed above can also be employed in the usual amounts to further enhance the properties of the compositions.

The powder coatings of this invention, which are solid particulate film-forming mixtures, are prepared by conventional manufacturing techniques used in the powder coating industry.

One important property of the powder coating composition according the invention is that the ingredients used in the composition can be dry blended together and then the blended, e.g. melt-blended material can be transformed to a powder coating composition using standard powder manufacturing processes known to a person skilled in the art, particularly using the extruder process. The melt-mixing process can proceed at a temperature sufficient to melt the resin in the mixture (preferably at a temperatures below 200° C.). After the extrusion process the extruded material is cooled on chill rolls to a solid, broken up and then ground to a fine powder.

Additional ingredients may be blended with the formed powder. This process step is included, for example, when the additional ingredient may be damaged or rendered useless by the extrusion, chilling, breaking or grinding processes, or when the additional ingredient may damage the equipment used for dry-blending, extrusion, chilling, breaking or grinding processes. For example, aluminium flake pigments are typically added at this step. These may be dry-blended or impact-fused (known as bonding) in the process known to a person skilled in the art.

The powder coating compositions of this invention may be applied by electrostatic spray, thermal or flame spraying, or fluidized bed coating methods, all of which are known to those skilled in the art. The coatings 5 may be applied to metallic and/or non-metallic substrates. Following deposition of the powder coating to the desired thickness, the coated substrate is typically heated in the range from about 200 to 260° C., to melt the composition and cause it to flow and cause the powder to cure and bond to the substrate and form a crosslinked polymer matrix. In certain 10 applications, the part to be coated may be pre-heated before the application of the powder, and then either heated after the application of the powder or not. Gas or electrical furnaces are commonly used for various heating steps, but other methods (e.g., microwave) are also known.

### EXAMPLES

The following raw materials were used:

| Name | Type | Manufacturer |
|---|---|---|
| Silres ® 602 | Polysiloxane (Silicone) Resin | Wacker Silicones |
| Silres ® 604 | Polysiloxane (Silicone) Resin | Wacker Silicones |
| Alzibronz 55 | High-Aspect Ratio Mica | Engelhard |
| Sodium tetraborate | Anhydrous alkali borate | Pfaltz & Bauer |
| Sodium borate | Hydrated alkali borate | EMD |
| decahydrate | | |
| Zinc borate | Non-alkali borate | US Borax |
| Benzoin | Degassing Aid | Aceto |
| Aluminum Oxide C | Dry-Flow Additive | Degussa |

### Comparative Examples 1-3

Examples 1 through 3 are outside the scope of the invention and are intended to illustrate the limitations of known technology.

### Comparative Example 1

This example demonstrates the limitations of polysiloxane-based coating formulations containing high-aspect ratio fillers.

Coating Powder CEx. 1 was prepared by blending 400 g of Silres® 602, 600 g of Silres® 604, 350 grams of Alzibronz 55, and 10 grams of benzoin. The blended materials were passed through a twin-screw extruder which melted the resin and further blended the mixture. The extrudate was solidified by passing between chilled rollers, then broken into flakes. The flakes were mixed with 1 Wt. % Aluminum Oxide C dry flow additive and ground through a hammer mill. The resulting powder was passed through an 80-mesh sieve to remove coarse particles to form Coating Powder CEx. 1.

Powder CEx. 1 was electrostatically applied to a cold-rolled steel panel 0.03″ thick and baked in a 260° C. oven for 15 minutes to form a coating. The crosshatch adhesion of the coating was tested after exposure to four different heat-aging conditions:
No additional heating. Results: strong cohesive film, crosshatch adhesion 3B (partial removal)
427° C. (800° F.) for 16 hours. Results: strong cohesive film, crosshatch adhesion 4B (slight removal)
538° C. (1000° F.) for 16 hours. Results: strong cohesive film, crosshatch adhesion 4B (slight removal)
Propane flame, approximately 730° C. (1350° F.) for 5 minutes.
Results: weak dusty film, crosshatch adhesion rating 0 due to cohesive failure

### Comparative Example 2

This example demonstrates the failure of zinc borate to improve the performance of polysiloxane-based coating formulations containing high-aspect ratio fillers.

Coating Powder CEx. 2 was prepared by blending 400 g of Silres® 602, 600 g of Silres® 604, 350 grams of Alzibronz 55, 200 grams of zinc borate (ZnBO3), and 10 grams of benzoin. The blended materials were passed through a twin-screw extruder which melted the resin and further blended the mixture. The extrudate was solidified by passing between chilled rollers, then broken into flakes. The flakes were mixed with 1 Wt. % Aluminum Oxide C dry flow additive and ground through a hammer mill. The resulting powder was passed through an 80-mesh sieve to remove coarse particles to form Coating Powder CEx. 2.

Powder CEx. 2 was electrostatically applied to a cold-rolled steel panel 0.032″ thick and baked in a 260° C. oven for 15 minutes to form a coating. The crosshatch adhesion of the coating was tested after exposure to two different heat-aging conditions:
No additional heating. Results: strong cohesive film, crosshatch adhesion 3B (partial removal)
Propane flame, approximately 730° C. (1350° F.) for 5 minutes. Results: weak flaky film, crosshatch adhesion rating 0 due to cohesive failure

### Comparative Example 3

This example demonstrates the consequences of preparing a polysiloxane composition containing hydrated alkali borates.

Coating Powder CEx. 3 was attempted by blending 400 g of Silres® 604, 600 g of Silres® 602, 350 grams of Alzibronz 55, 200 grams of sodium borate decahydrate (Na2B4O7.10H2O), and 10 grams of benzoin. When the blended materials were introduced into a twin-screw extruder the composition reacted and seized up the extruder. No further processing was attempted.

### Example 1

This example is within the scope of the invention and demonstrates the improvement in adhesion resulting from the inclusion of an anhydrous alkali borate in the composition.

Coating Powder Ex. 1 was prepared by blending 400 g of Silres® 604, 600 g of Silres® 604, 350 grams of Alzibronz 55, 200 grams of sodium tetraborate (Na2B4O7), and 10 grams of benzoin. The blended materials were passed through a twin-screw extruder which melted the resin and further blended the mixture. The extrudate was solidified by passing between chilled rollers, then broken into flakes. The flakes were mixed with 1 Wt. % Aluminum Oxide C dry flow additive and ground through a hammer mill. The resulting powder was passed through an 80-mesh sieve to remove coarse particles to form Coating Powder Ex. 1.

Powder Ex. 1 was electrostatically applied to a cold-rolled steel panel 0.032″ thick and baked in a 260° C. oven for 15 minutes to form a coating. The crosshatch adhesion of the coating was tested after exposure to four different heat-aging conditions:
No additional heating. Results: strong cohesive film, crosshatch adhesion 3B (partial removal)
427° C. (800° F.) for 16 hours. Results: strong cohesive film, crosshatch adhesion 4B (slight removal)
538° C. (1000° F.) for 16 hours. Results: strong cohesive film, crosshatch adhesion 4B (slight removal)
Propane flame, approximately 730° C. (1350° F.) for 5 minutes. Results: strong cohesive film, crosshatch adhesion rating 3 (partial removal).

The delamination-resistance of the coating was tested by heating the coated panel from the back side to red heat (approximately 730° C.) in a propane/air flame for five minutes then allowing it to cool. Upon cooling, the coating did not suffer flaking or delamination.

What is claimed is:

1. A melt-blendable, film-forming powder coating composition for producing a high temperature resistant coating, comprising
(A) at least one polysiloxane resin, and
(B) from 0.01 to 50 parts by weight (pbw) based on 100 pbw binder of at least one inorganic anhydrous borate based on at least one alkali metal.

2. The composition of claim 1 wherein the amount of the inorganic anhydrous borate is in the range of 0.5 to 50 pbw based on 100 pbw binder.

3. The composition of claim 1 wherein inorganic anhydrous borate is selected from the group consisting of sodium tetraborate, lithium tetraborate and anhydrous borax.

4. A process for manufacture the powder coating composition of claim 1 comprising
(a) melt-blending the components of the composition, and
(b) transforming the melt-blended material to a powder coating composition using standard powder manufacturing processes.

5. An article having coated and cured thereon, at least one coating layer formed from the powder coating composition of claim 1.
